(19) United States
(12) Patent Application Publication
(10) Pub. No.: US 2005/0175188 A1
(43) Pub. Date: Aug. 11, 2005

(54) Multimedia microphone device

(76) Inventor: Chin-Chun Chen, Taipei City (TW)

Correspondence Address: FROMMER LAWRENCE & HAUG, 745 FIFTH AVENUE- 10TH FL., NEW YORK, NY, 10151, US

(21) Appl. No.: 10/820,235

(22) Filed: Apr. 6, 2004

(30) Foreign Application Priority Data
Feb. 11, 2004 (TW) 093201936

(51) Int. Cl. H04R 1/02; H04R 3/00

(52) U.S. Cl. 381/91; 381/122

(57) ABSTRACT

A multimedia microphone device includes a base, an upright support member, a sound pickup unit, a control circuit, a host transmission unit, and an expansion transmission unit. The upright support member is coupled to the base and has the sound pickup unit mounted thereon. The control circuit is mounted in the base, and is coupled electrically to the sound pickup unit. The host transmission unit is mounted on the base, and is adapted to establish signal transmission between the control circuit and an external host terminal so as to permit transmission of signals picked up by the sound pickup unit to the host terminal. The expansion transmission unit is mounted on the base, and is adapted to establish signal transmission between the control circuit and an external peripheral device such that the host terminal is able to communicate with the peripheral device through the control circuit.

### CROSS-REFERENCE TO RELATED APPLICATION

This application claims priority of Taiwanese application no. 093201936, filed on Feb. 11, 2004.

### BACKGROUND OF THE INVENTION

1. Field of the Invention

The invention relates to a microphone device, more particularly to a multimedia microphone device with an expansion transmission unit for added functionality.

2. Description of the Related Art

A conventional microphone device for computer applications is only configured for use as an input device, in which sound signals are picked up and are transmitted to a computer for processing. It is desirable to expand the functionality of the microphone device for improving consumer appeal.

### SUMMARY OF THE INVENTION

Therefore, the object of the present invention is to provide a multimedia microphone device that includes an expansion transmission unit so as to enhance its functionality.

Accordingly, a multimedia microphone device of this invention comprises a base, an upright support member, a sound pickup unit, a control circuit, a host transmission unit, and an expansion transmission unit. The upright support member has a lower coupling end coupled to the base, and an upper mounting end. The sound pickup unit is mounted on the upper mounting end of the support member. The control circuit is mounted in the base, and is coupled electrically to the sound pickup unit. The host transmission unit is mounted on the base, is coupled electrically to the control circuit, and is adapted to establish signal transmission between the control circuit and an external host terminal so as to permit transmission of signals picked up by the sound pickup unit to the host terminal. The expansion transmission unit is mounted on the base, is coupled electrically to the control circuit, and is adapted to establish signal transmission between the control circuit and an external peripheral device such that the host terminal is able to communicate with the peripheral device through the control circuit.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a multimedia microphone device according to the present invention;

FIG. 2 is an assembled perspective view to illustrate a base of the preferred embodiment;

FIG. 3 is an assembled perspective view of the preferred embodiment; and

FIG. 4 is a simplified schematic circuit block diagram of the preferred embodiment to illustrate connection with an external host terminal and an external peripheral device.

### DETAILED DESCRIPTION OF THE PREFERRED EMBODIMENT

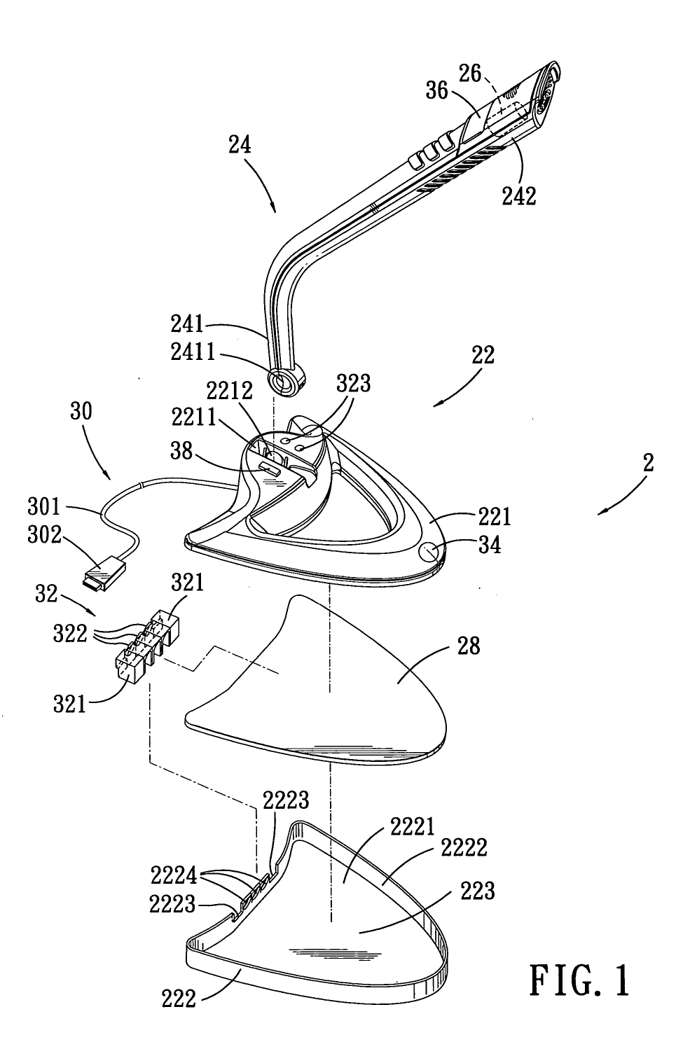

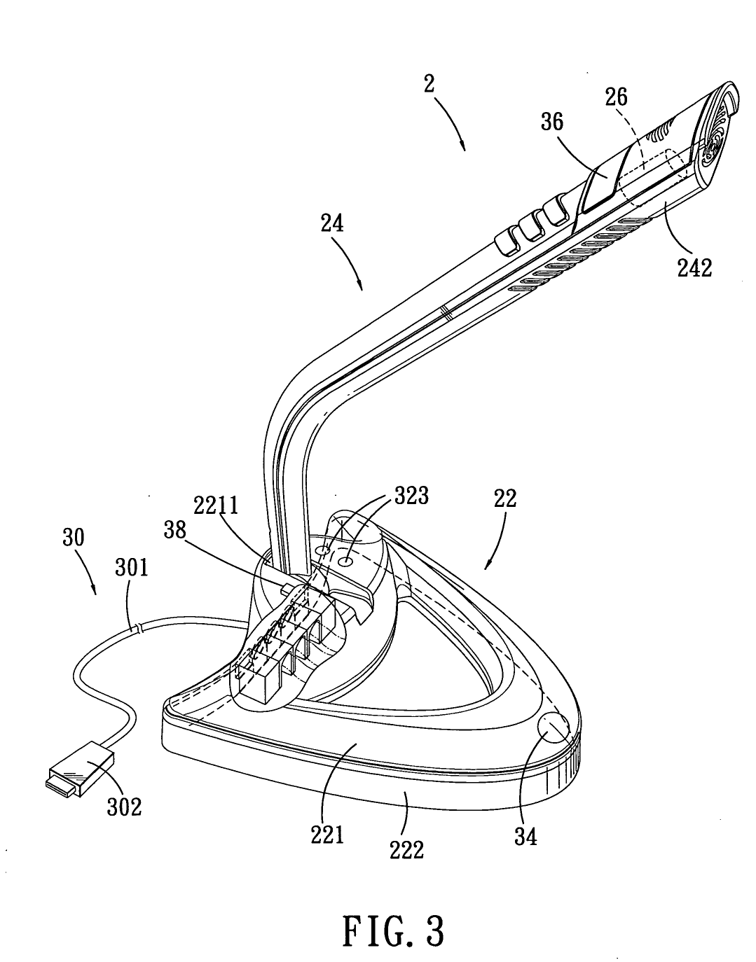

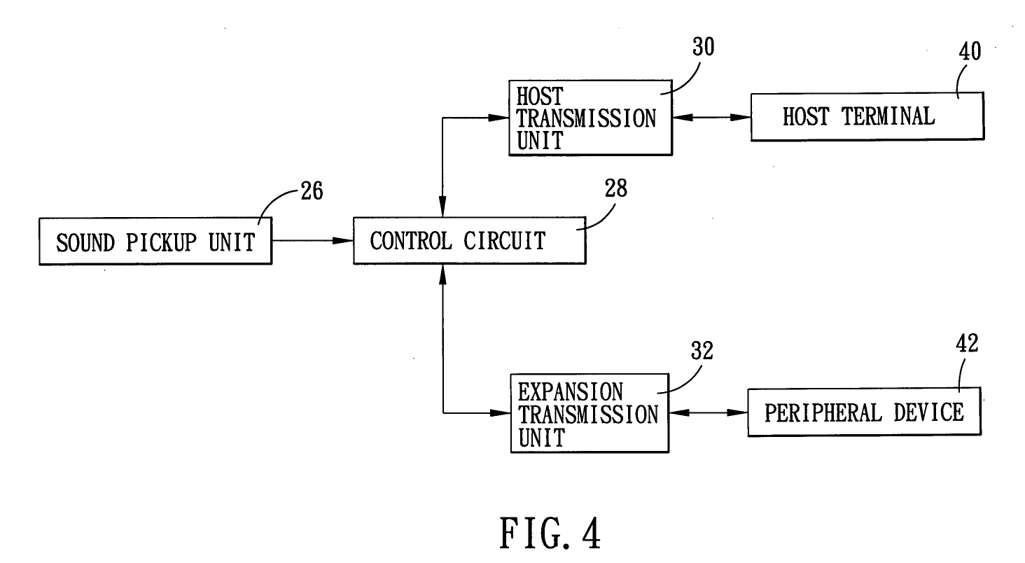

Referring to FIGS. 1 to 4, the preferred embodiment of a multimedia microphone device 2 according to the present invention is shown to include a base 22, an upright support member 24, a sound pickup unit 26, a control circuit 28, a host transmission unit 30, and an expansion transmission unit 32.

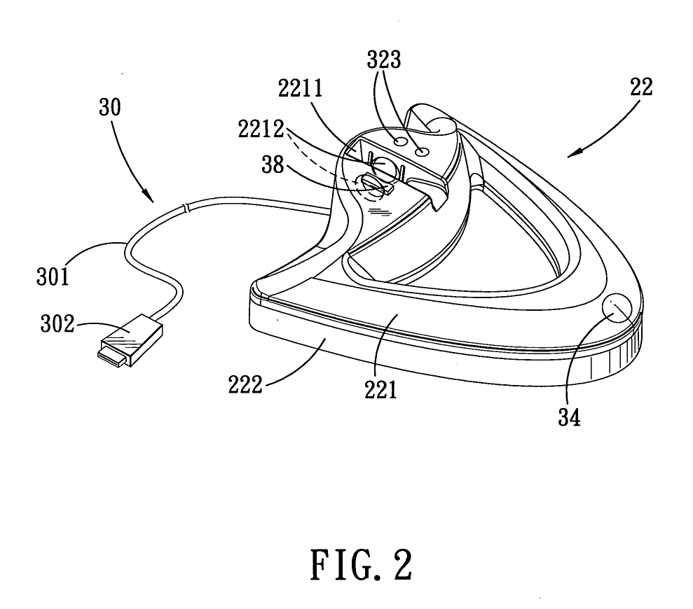

The base 22 includes complementary upper and lower casing parts 221, 222. The lower casing part 222 includes a bottom wall 2221 and a peripheral wall 2222 extending upwardly from a periphery of the bottom wall 2221. The peripheral wall 2222 has a rear portion that is formed with a pair of notches 2223 and three through holes 2224 disposed between the notches 2223. The upper casing part 221 cooperates with the lower casing part 222 to define a receiving space 223. The upper casing part 221 has a rear portion formed with a coupling hole 2211, and a pair of pivot blocks 2212 (see FIG. 2) projecting from opposite hole-defining walls of the coupling hole 2211.

The upright support member 24 has a lower coupling end 241 and an upper mounting end 242. The lower coupling end 241 extends into the coupling hole 2211, and is formed with a pair of recesses 2411, each of which engages a respective one of the pivot blocks 2212 such that the lower coupling end 241 of the support member 24 is coupled pivotally to the base 22.

The sound pickup unit 26 is mounted on the upper mounting end 242 of the support member 24, and generates electrical signals that correspond to sounds picked up thereby in a conventional manner. Preferably, the support member 24 is made from a bendable material to facilitate adjustment of the position of the sound pickup unit 26 when the microphone device 2 is in use.

The control circuit 28 is mounted in the receiving space 223 of the base 22, and is coupled electrically to the sound pickup unit 26 by means of signal wires (not shown) in the support member 24. The control circuit 28 includes a circuit board and a plurality of electronic components (not illustrated for the sake of simplicity) mounted on the circuit board.

The host transmission unit 30 is mounted on the base 22, is coupled electrically to the control circuit 28, and is adapted to establish signal transmission between the control circuit 28 and an external host terminal 40, such as a computer, so as to permit transmission of signals picked up by the sound pickup unit 20 to the host terminal 40. The host transmission unit 30 can be a wired transmission unit or a wireless transmission unit. In this embodiment, the host transmission unit 30 is a wired transmission unit that includes a transmission cable 301 connected to the control circuit 28 at one end and terminated by a universal serial bus (USB) connector 302 at the other end. It is noted herein that, when the host transmission unit 30 is a wireless transmission unit, the host terminal 40 must be equipped with a compatible wireless transceiver module.

The expansion transmission unit 32 is mounted on the base 22, is coupled electrically to the control circuit 28, and is adapted to establish signal transmission between the control circuit 28 and an external peripheral device 42 such that the host terminal 40 is able to communicate with the peripheral device 42 through the control circuit 28. In this embodiment, the expansion transmission unit 32 includes first and second USB ports 321, each of which is mounted on the base 22 in a respective one of the notches 2223, and three signal jacks 322, each of which is aligned with a respective one of the through holes 2224 in the base 22. The first and second USB ports 321 can be connected to a mouse, a signal transmission cable, etc. The signal jacks 322 can be connected to an earphone, a speaker, another microphone, etc. In practice, the numbers and locations of the USB ports 321 and the signal jacks 322 can vary depending on design requirements. Preferably, the expansion transmission unit 32 further includes first and second status indicators 323 mounted on the base 22 and coupled electrically to and controlled by the control circuit 28 so as to indicate operating status of a respective one of the first and second USB ports 321. In this embodiment, each of the first and second status indicators 323 is a light emitting diode.

In addition, a power switch 34 is mounted on the base 22, is coupled to the control circuit 28, and is operable so as to control activation and deactivation of the microphone device 2. A power indicator 36 is mounted on the upper mounting end 242 of the support member 24, and is coupled electrically to and controlled by the control circuit 28 so as to provide a visible indication when the microphone device 2 is in an activated state. Furthermore, a function select switch 38 is mounted on the base 22, is coupled to the control circuit 28, and is operable so as to enable selection of one of the signal jacks 322 by the control circuit 28.

In use, the USB connector 302 of the host transmission unit 30 is connected to the host terminal 40, such as a computer, and the power switch 34 is operated to activate the microphone device 2 and the power indicator 36. Due to the pivot connection between the support member 24 and the base 22, the microphone device 2 can be adjusted to optimize sound pickup by the sound pickup unit 26. If desired, external speakers, microphones and other peripheral devices may be connected to the host terminal 40 through the expansion transmission unit 32 and the control circuit 28. Furthermore, through the function select switch 38 and the status indicators 323, the operating status of the control circuit 28 can be observed.

It has thus been shown that, due to the presence of the expansion transmission unit 32 that is coupled to the control circuit 28, the multimedia microphone device 2 of this invention has an added function of connecting a host terminal 40 to an external peripheral device 42.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A multimedia microphone device comprising:
a base;
an upright support member having a lower coupling end coupled to said base, and an upper mounting end;
a sound pickup unit mounted on said upper mounting end of said support member;
a control circuit mounted in said base and coupled electrically to said sound pickup unit;
a host transmission unit mounted on said base, coupled electrically to said control circuit, and adapted to establish signal transmission between said control circuit and an external host terminal so as to permit transmission of signals picked up by said sound pickup unit to the host terminal; and
an expansion transmission unit mounted on said base, coupled electrically to said control circuit, and adapted to establish signal transmission between said control circuit and an external peripheral device such that the host terminal is able to communicate with the peripheral device through said control circuit.

2. The multimedia microphone device as claimed in claim 1, wherein said lower coupling end of said support member is coupled pivotally to said base.

3. The multimedia microphone device as claimed in claim 1, wherein said support member is bendable.

4. The multimedia microphone device as claimed in claim 1, wherein said host transmission unit is a wired transmission unit.

5. The multimedia microphone device as claimed in claim 1, wherein said host transmission unit is a wireless transmission unit.

6. The multimedia microphone device as claimed in claim 1, wherein said expansion transmission unit includes first and second universal serial bus ports.

7. The multimedia microphone device as claimed in claim 6, wherein said expansion transmission unit further includes first and second status indicators mounted on said base, and coupled electrically to and controlled by said control circuit to indicate operating status of a respective one of said first and second universal serial bus ports.

8. The multimedia microphone device as claimed in claim 7, wherein each of said first and second status indicators is a light emitting diode.
